(19) United States
(12) Patent Application Publication
(10) Pub. No.: US 2007/0030534 A1
(43) Pub. Date: Feb. 8, 2007

(54) Image Reading Device

(75) Inventors: Takahiro Ikeno, Nagoya-shi, Aichi-ken (JP); Yoshinori Osakabe, Nagoya-shi, Aichi-ken (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 11/462,530

(22) Filed: Aug. 4, 2006

(30) Foreign Application Priority Data
Aug. 8, 2005 (JP) 2005229158

(51) Int. Cl. H04N 1/00

(52) U.S. Cl. 358/498; 358/401

(57) ABSTRACT

An image reading device, including: an image sensor which includes a case having an elongate configuration and light-receiving elements arranged in a row in a lengthwise direction of the case and which reads an image; a carriage on which is mounted the image sensor; a guide member which supports the carriage at a support position that corresponds to a substantially lengthwise middle of the image sensor, for guiding a reciprocating movement of the carriage; a pulling member connected to the carriage at a connect position which is determined such that a vertical line from the connect position passes the guide member; and a drive mechanism which reciprocates the pulling member along the guide member.

This application is based on Japanese Patent Application No. 2005-229158 filed on Aug. 8, 2005, the contents of which are incorporated hereinto by reference.

### BACKGROUND OF THE INVENTION

1. Field of the Invention

The present invention relates to an image reading device which includes a pulling member connected to an image sensor or a carriage that carries the image sensor and which performs image reading by reciprocating the image sensor along a guide member by means of a drive mechanism.

2. Discussion of Related Art

There is conventionally known a so-called flatbed-type image reading device in which an image sensor is reciprocated with respect to a platen glass for thereby reading an image of a document or original placed on the platen glass.

FIG. 11 is a cross sectional view showing an internal structure of a conventional flatbed-type image reading device. In the image reading device indicated at 90 in FIG. 11, a platen glass 92 is exposed to an upper surface of a body 91, and a carriage 94 which carries an image sensor 93 is provided below the platen glass 92 so as to be reciprocable parallel to the platen glass 92. Below the carriage 94, there is provided a guide rod 95 extending in a direction of the reciprocating movement of the carriage 94. The carriage 94 has a rod-receiving portion 96 formed in its lower surface for engagement with the guide rod 95. Thus, the carriage 94 is held by the guide rod 95 and is slidably movable along the same 95. On the lower surface of the carriage 94, there is formed a belt holding portion 97 for holding a timing belt which is rotated by a drive mechanism, In FIG. 11, the drive mechanism and the timing belt are not shown. Thus, the carriage 94 and the timing belt are connected to each other. When the timing belt is rotated, the carriage 94 is reciprocated along the guide rod 95.

As shown in FIG. 11, the belt holding portion 97 is located at a position apart from the rod-receiving portion 96 in the longitudinal direction of the carriage 94. A pulling force is transmitted to the belt holding portion 97 from the timing belt. When the carriage 94 slides on the guide rod 95, the rod-receiving portion 96 suffers from sliding friction arising from the sliding of the carriage 94 relative to the guide rod 95. Because the pulling force and the sliding friction act on the carriage 94 in opposite directions, there is generated, in the carriage 94, horizontal rotation moment. Further, the rod-receiving portion 96 is formed in the vicinity of a center of the carriage 94 corresponding to a center of gravity of the carriage 94 for permitting the carriage 94 to be supported by the guide rod 95 with good balance. Accordingly, the pulling force indicated above acts on the carriage 94 at a position offset from the center of gravity of the same 94. Therefore, the horizontal rotation moment is generated in the carriage 94. The rotation moment generated as described above causes various problems such as vibration of the carriage 94 during its reciprocating movement and inclination of a direction of a read line of the image sensor 93 mounted on the carriage 94, from a nominal direction.

To prevent the generation of the rotation moment acting on the carriage 94, a structure as disclosed in JP-A-5-300333, for instance, may be considered. In the disclosed structure, the carriage 94 is supported by two guide rods respectively disposed at lengthwise opposite ends of the carriage 94, and two timing belts are connected to the carriage 94 at its lengthwise opposite ends near the respective guide rods. Where the positional relationship between a support position at which the carriage is supported by the guide rod and a connect position at which the timing belt is connected to the carriage is made equal at the opposite ends of the carriage 94, the rotation moments generated at the opposite ends of the carriage 94 arising from a distance between the support position and the connect position are canceled to each other. Further, where the connect position at which the carriage 94 is connected to one of the two timing belts and the connect position at which the carriage 94 is connected to the other of the two timing belts are made symmetrical with respect to the center of gravity of the carriage 94, it is possible to avoid the rotation moment arising from the pulling force acting on the carriage 94 at the position offset from its center of gravity.

### SUMMARY OF THE INVENTION

In the above-mentioned structure in which the two guide rods are respectively disposed at the opposite ends of the carriage 94 for holding the same 94 and the two timing belts are respectively connected to the vicinities of the opposite ends of the carriage 94, two sets of the guide rods and the timing belts are needed. Further, there is a need to provide, at the respective opposite ends of the carriage 94, two drive mechanisms for rotating the respective timing belts. Therefore, the structure indicated above increases the number of components and the number of assembling steps, resulting in increased cost. Moreover, the above-indicated structure needs enough space for disposing the two sets of the timing belts and the guide rods at the respective opposite ends of the carriage 94, undesirably increasing the size of the device, contrary to a demand for downsizing the device.

It is therefore an object of the present invention to provide an image reading device which assures stable and accurate image reading without causing vibration or inclination of an image sensor during its reciprocating movement and which realizes reduction in cost and size.

The object indicated above may be achieved according to a first aspect of the present invention, which provides an image reading device, comprising: an image sensor which includes a case having an elongate configuration and light-receiving elements arranged in a row in a lengthwise direction of the case and which reads an image; a carriage on which is mounted the image sensor; a guide member which supports the carriage at a support position that corresponds to a substantially lengthwise middle of the image sensor, for guiding a reciprocating movement of the carriage; a pulling member connected to the carriage at a connect position which is determined such that a vertical line from the connect position passes the guide member; and a drive mechanism which reciprocates the pulling member along the guide member.

The object indicated above may also be achieved according to a second aspect of the present invention, which provides an image reading device, comprising: an image sensor which includes a case having an elongate configuration and light-receiving elements arranged in a row in a lengthwise direction of the case and which reads an image; a guide member which supports the image sensor at a support position that corresponds to a substantially lengthwise middle of the image sensor, for guiding a reciprocating movement of the image sensor; a pulling member connected to the image sensor at a connect position which is determined such that a vertical line from the connect position passes the guide member; and a drive mechanism which reciprocates the pulling member along the guide member.

The carriage or the image sensor is supported by the guide member at a support position that corresponds to a substantially lengthwise middle of the image sensor. The pulling member is connected to the carriage or the image sensor The pulling member is reciprocated by the drive mechanism along the guide member, whereby the image sensor or the carriage carrying the image sensor thereon is pulled by the pulling member and reciprocated while being guided by the guide member. Thus, the image sensor scans the medium to be read, thereby reading an image, In the image reading device constructed according to the above-indicated first and the second aspects of the present invention, the pulling member is connected to the carriage or the image sensor at the connect position which is determined such that a vertical line from the connect position passes the guide member. Namely, the connect position is located right above or right below the guide member. Therefore, a force applied from the pulling member to the carriage or the image sensor causes no moment that rotates the carriage or the image sensor. According to the arrangements, the force applied from the pulling member to the carriage or the image sensor is balanced in the lengthwise direction of the image sensor. As a result, the image sensor is prevented from being inclined during the reciprocating movement, assuring accurate and stable image reading.

### BRIEF DESCRIPTION OF THE DRAWINGS

The above and other objects, features, advantages and technical and industrial significance of the present invention will be better understood by reading the following detailed description of presently preferred embodiments of the invention, when considered in connection with the accompanying drawings, in which:

FIG. 1 is a perspective view showing an external structure of a multi-function device according to a first embodiment of the present invention;

FIG. 2 is a perspective view of the multi-function device of FIG. 1 with a document cover 7 placed in an open state;

FIG. 3 is a schematic perspective view showing an internal structure of a document placing board of the multi-function device of FIG. 1;

FIG. 4 is a plan view showing a structure of a CIS of the multi-function device of FIG. 1;

FIG. 5 is a plan view showing a carriage on which the CIS is mounted;

FIG. 6 is a side view showing the carriage on which the CIS is mounted;

FIG. 7 is a vertical cross sectional view showing the internal structure of the document placing board;

FIG. 8 is an enlarged view showing an encircled portion in FIG. 3;

FIG. 9 is a vertical cross sectional view showing a structure of a carriage according to a modified example of the first embodiment;

FIG. 10 is a perspective view showing a structure of a CIS according to a second embodiment of the invention; and

FIG. 11 is a vertical cross sectional view showing an internal structure of a conventional image reading device.

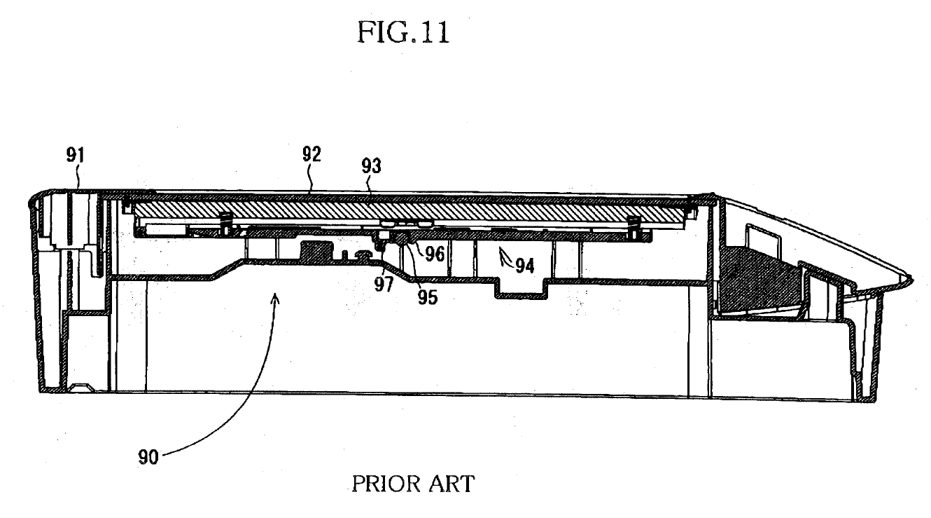

### DETAILED DESCRIPTION OF THE PREFERRED EMBODIMENTS

There will be described in detail preferred embodiments of the present invention with reference to the accompanying drawings.

### First Embodiment

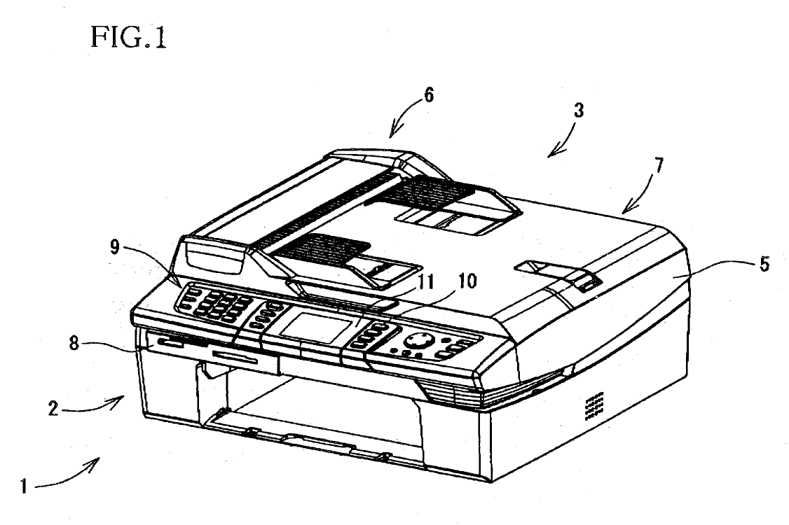

Referring first to the perspective view of FIG. 1, there is shown an external structure of a multi-function device (MFD) 1 according to a first embodiment of the invention. The multi-function device 1 includes a printing section 2 at its lower portion and a scanning section 3 at its upper portion and has a printing function, a scanning function, a copying function, and a facsimile function. An image reading device of the present invention is realized as the scanning section 3 of the multi-function device 1. It is noted that the multi-function device 1 is one arrangement of the present invention and that the image reading device according to the present invention may be embodied as a scanner as a single unit, an image, reading section of a copying machine, or the like

The multi-function device 1 is connected principally to a computer, not shown, and transfers image data read by the scanning section 3 to the computer. The image data read by the scanning section 3 may be stored in various types of memory media such as memory cards installed on the multi-function device 1. Based on image data and document data transferred from the computer, images and documents can be recorded on recording sheets using the printing section 2. Because the sections other than the scanning section 3 that realizes the scanning function are not related directly to the present invention, those sections are not explained.

As shown in FIG. 1, an operator's control panel 9 is provided on a front side of the multi-function device 1. The control panel 9 includes various operation keys 10 and a liquid crystal display portion 11. The operator inputs desired commands through the control panel 9, and the multi-function device 1 performs suitable operations in response to the inputted commands. In addition to the commands inputted through the control panel 9, the multi-function device 1 is arranged to perform operations by commands transmitted from the computer connected thereto, via a printer driver or a scanner driver.

At an upper left portion of the front side of the multi-function device 1, there is formed a slot 8 into which a small-sized memory card of various types as the memory medium is insertable. The image data read by the scanning section 3 can be stored in the small-sized memory card inserted in the slot 8. Further, the image data can be read from the memory card and indicated on the liquid crystal display portion 11. In addition, arbitrary image data stored in the memory card can be printed in the printing section 2. The commands for these operations are inputted through the control panel 9.

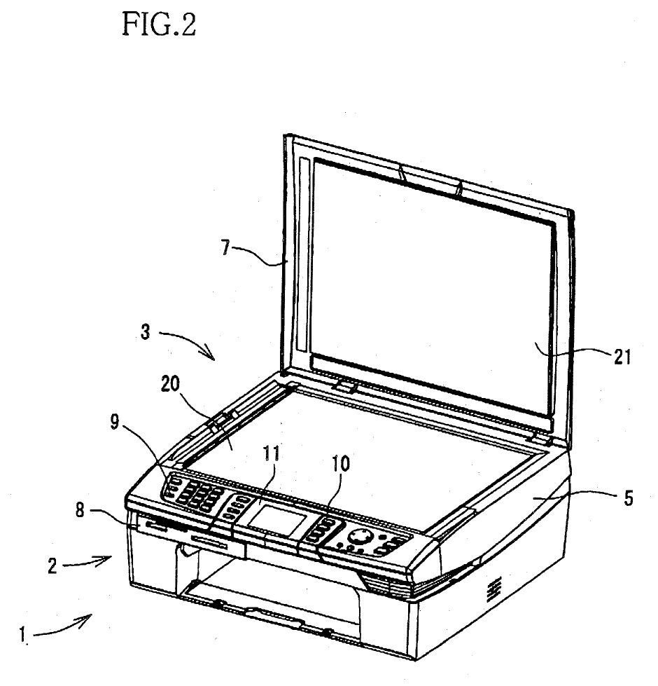

Next, the scanning section 3 is explained. As shown in FIGS. 1 and 2, the scanning section 3 includes: a document placing board 5 functioning as a flatbed scanner (FBS); and a document cover 7 equipped with an automatic document feeder 6 (hereinafter referred to as “ADF). The document cover 7 is attached to the document placing board 5 via hinges at a rear side of the multi-function device 1 so as to be openable and closable. The document placing board 5 is a body of the multi-function device 1. When the original cover 7 is in a closed state, the document cover 7 partially constitutes the upper surface of the multi-function device 1. Because the structure and function of the ADF are not related directly to the present invention, a detailed explanation of the ADF 6 is omitted.

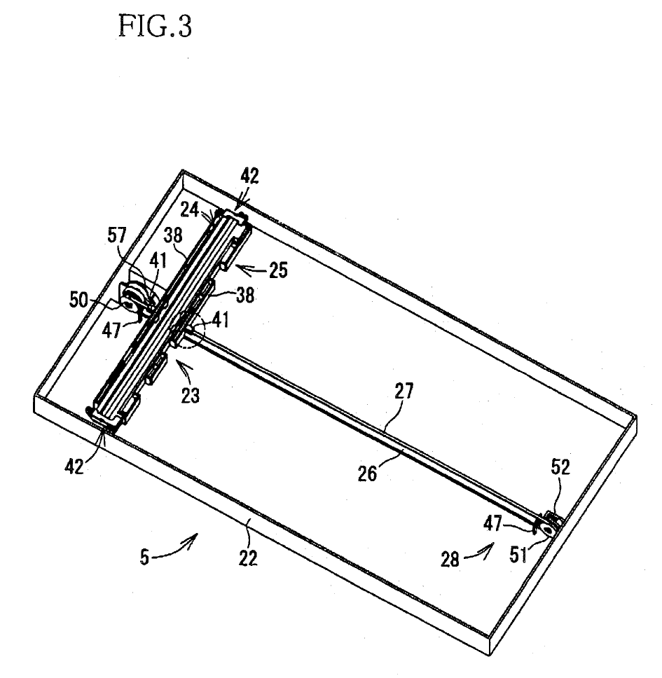

As shown in the perspective view of FIG. 2 showing the multi-function device 1 with the document cover 7 placed in an open state, a platen glass 20 is provided on the upper surface of the document placing board 5. When the document cover 7 is placed in the closed state shown in FIG. 1, the platen glass 20 is covered by the document cover 7. On the lower surface of the document cover 7, there is provided a press member 21 which is composed of a sponge, a white plate and so on. The platen glass 20 is a transparent glass plate, for instance, on which a document is placed when the scanning section 3 is used as the FBS. A document sheet with an A4 size or a letter size at maximum can be placed on the platen glass 20, such that the rectangular document sheet is placed with its longitudinal direction coinciding with the width direction of the multi-function device of FIG. 1. When the document cover 7 is closed, the document is fixedly positioned on the platen glass 20. In this state, an image reading unit 23 which will be explained with reference to FIG. 3 is moved along the platen glass 20 to scan the image, whereby the image of the document is read by the FBS. The platen glass 20 constitutes a read surface when the image reading is performed using the ADF 6.

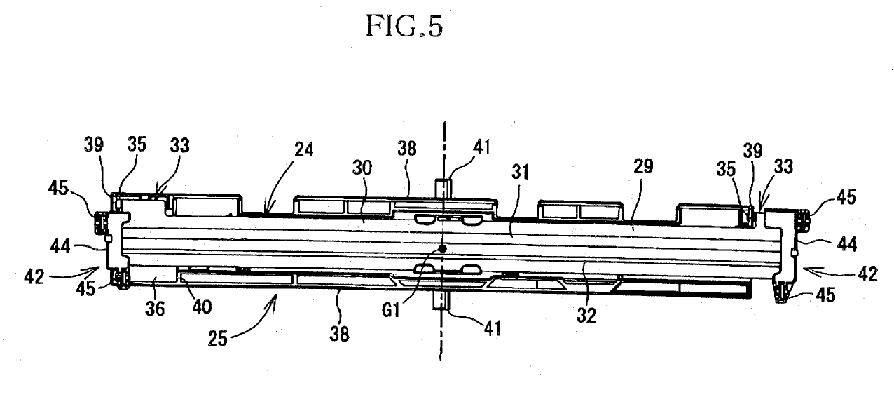

FIG. 3 is a schematic perspective view showing an internal structure of the document placing board 5. Within a lower frame 22 of the body of the document placing board 5, the image scanning unit 23 is disposed. In the lower frame 22, there are provided a housing of the control panel 9, supporting ribs for supporting the platen glass 20, boss portions for fastening various components with screws, through-holes for electric wires and the like. These may be suitably designed depending upon the arrangement of the document placing board 5 and are not illustrated in FIG. 5.

The image reading unit 23 includes: a contact image sensor 24 (hereinafter referred to as “CIS”); a carriage 25; a guide rod 26 as a guide member; a timing belt 27 as a pulling member; and a belt drive mechanism 28 as a drive mechanism. Because the image reading unit 23 employs the CIS 24, the image sensor has a reduced size and weight, so that the scanning section 3 is made small and thin.

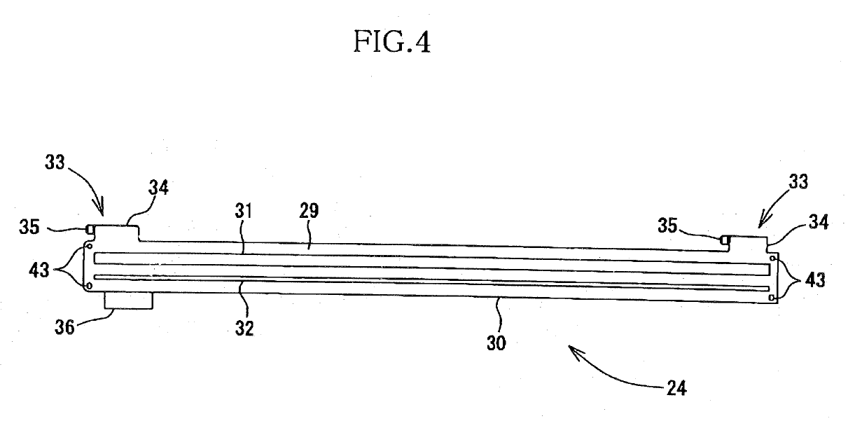

As shown in the plan view of FIG. 4, the CIS 24 has: an upper surface 29 which is an elongate, rectangular flat surface in its plan view; and a case 30 whose overall configuration is elongate, rectangular parallelepiped. On the upper surface 29 of the case 30, there is provided a light guide 31 extending in the longitudinal direction of the case 30, for guiding a light of LED incorporated in the case 30. The light of the LED is emitted through the light guide 31 toward the upper surface 29 of the case 30 of the CIS 24 along the longitudinal direction. On the upper surface 29 of the case 30, a condenser lens 32 composed of a plurality of lens portions is disposed in the longitudinal direction of the case 30 so as to be parallel to the light guide 31. Further, inside the case 30, a plurality of light receiving elements are arranged, right below the condenser lens 32, in a row extending in the same direction as the direction of extension of the condenser lens 32. The light emitted from the LED is reflected on the document placed on the platen glass 20, and the reflected light is condensed at the light receiving elements by the condenser lens 32. The light receiving elements are so-called photoelectric conversion elements which output electric signals in accordance with the intensity of the reflected light. The longitudinal direction of the case 30 of the CIS 24 corresponds to a main scanning direction in the mage reading. The length of the case 30 of the CIS 24 in the main scanning direction, i.e., the longitudinal size of the case 30, corresponds to the length of a medium with a maximum size that can be read by the CIS 24. The CIS 24 performs image reading along a read line corresponding to the longitudinal direction of the case 30 of the CIS 24 and outputs electric signals for every read line.

The case 30 of the CIS 24 is formed with positioning portions 33 for positioning the CIS 24 relative to the carriage 25 in a sub scanning direction, i.e., in a direction perpendicular to the main scanning direction. Each positioning portion 33 includes a bracket 34 that protrudes from one of widthwise opposite ends of the case 30 and a pin 35 that protrudes from the bracket 34 in the longitudinal direction of the case 30. The pin 35 is to be held in engagement with a pin-receiving portion 39 (which will be explained) of the carriage 25, whereby the CIS 24 is positioned relative to the carriage 25 in the sub scanning direction. At the other of the widthwise opposite ends of the case 30, there is formed a convex portion 36 which is to be held in engagement with a recessed portion 40 (which will be explained) of the carriage 25 for positioning the CIS 24 relative to the carriage 25 in the main scanning direction.

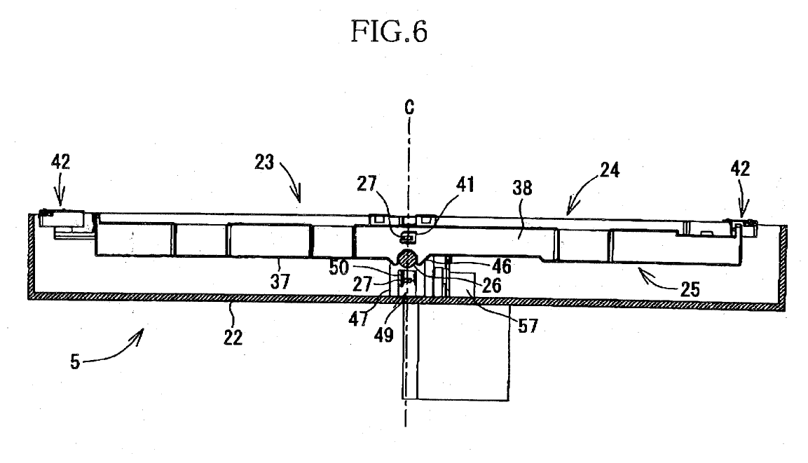

As shown in the plan view of FIG. 5, the carriage 25 is in the form of a container on which the CIS 24 is mounted. The carriage 25 has a bottom portion 37 (shown in FIG. 6) and a pair of walls 38 which respectively extend upright from opposite ends of the bottom portion 37 in the sub scanning direction. The walls 38 constitute side surfaces of the carriage 25 in its reciprocating movement direction. The CIS 24 is accommodated in a space defined by the bottom portion 37 and the walls 38 of the carriage 25. No walls are formed on opposite ends of the bottom portion 37 in the main scanning direction, and the CIS 24 protrudes at one of its lengthwise opposite ends from a corresponding one of lengthwise opposite ends of the carriage 25. The carriage 25 is open at its upper end in which is exposed the upper surface 29 of the CIS 24 mounted on the carriage 25.

On one of the two walls 38 of the carriage 25, there are formed pin-receiving portions 39 which are to be held in engagement with the respective positioning portions 33 of the CIS 24, Each pin-receiving portion 39 is an elongate hole which extends in the vertical direction and into which the pin 35 of the corresponding positioning portion 33 of the CIS 24 is inserted, whereby the positioning portion 33 and the pin-receiving portion 39 are brought into engagement with each other. The pin-receiving portions 39 of the carriage 25 are formed so as to correspond to the respective positioning portions 33 of the CIS 24. The other of the two walls 38 of the carriage 25 has, at its inner surface, the above-indicated recessed portion 40 so as to correspond to the convex portion 36 of the CIS 24. The recessed portion 40 of the carriage 25 and the convex portion 36 of the CIS 24 come into engagement with each other, whereby the CIS 24 is positioned with respect to the carriage 25 in the main scanning direction.

In the exemplary embodiments the positioning of the CIS 24 with respect to the carriage 25 in the sub scanning direction is made by the positioning portions 33 formed on the case 30 of the CIS 24 while the positioning in the main scanning direction is made by the convex portion 36 formed on the same. The above-indicated manner of positioning of the CIS 24 with respect to the carriage 25 is one example and the shapes of those portions 33, 36 and the direction of the positioning may be suitably changed.

Two holding portions 41 are formed on the respective walls 38 of the carriage 25. Each holding portion 41 is for holding the timing belt 27 and thereby connecting the carriage 25 and the timing belt 27 to each other. Namely, the position of each holding portion 41 corresponds to a connect position according to the present invention. The structure of the holding portions 41 will be explained in detail.

Two roller units 42 are provided at the lengthwise opposite ends of the CIS 24, respectively. As shown in FIG. 4, positioning holes 43 are formed at opposite ends of the upper surface 29 of the CIS 24 for positioning the roller units 42 with respect to the CIS 24. Into the positioning holes 43, there are inserted pins which are formed to protrude from the bottom surface of the roller units 42, whereby the roller units 42 are fixedly positioned relative to the lengthwise opposite ends of the CIS 24, as shown in FIG. 5. Each roller unit 42 has a frame 44 and a pair of rollers 45 that are supported by the frame 44 so as to be rotatable in the widthwise direction of the CIS 24. The two rollers 45 of each roller unit 42 protrude upward from the upper surface 39 of the CIS 24 by the same amount. The rollers 45 of the two roller units 42 are held in abutting contact with the back surface of the platen glass 20, whereby a distance between the upper surface 29 of the CIS 24 and the back surface of the platen glass 20 is kept constant. Further, the CIS 24 smoothly moves relative to the platen glass 20 by rotation of the rollers 45.

As shown in FIG. 6, the CIS 24 is mounted on the upper portion of the carriage 25 so as to be held and supported by the same 25. The carriage 25 is formed, at its lower surface, with a rod-receiving portion 46 into which the guide rod 26 is received. The guide rod 26 and the rod-receiving portion 46 are held in engagement with each other, so that the carriage 25 is supported by the guide rod 26 and is slidaly movable in the axial direction of the guide rod 26. The rod-receiving portion 46 constitutes a guide-member engaging portion. The position of the rod-receiving portion 46 corresponds to a support position according to the present invention.

While not shown, suitable biasing members such as coil springs may be disposed between the CIS 24 and the carriage 25. The CIS 24 mounted on the carriage 25 is urged by the coil springs and held in pressing contact with the lower surface of the platen glass 20. As explained above, the roller units 42 are respectively provided at the lengthwise opposite ends of the CIS 24. The CIS 24 is smoothly moved parallel to the platen glass 20 together with the carriage 25 while the distance between the lower surface of the platen glass 20 and the upper surface 29 of the CIS 24 is kept constant owing to the rollers 45 of the roller units 42. Where the platen glass 20 is deflected, the coil springs are elastically deformed, so that the CIS 24 is displaced downward. Thus, the deflection of the platen glass 20 is absorbed by the coil springs, whereby the distance between the lower surface of the platen glass 20 and the upper surface 29 of the CIS 24 can be kept constant.

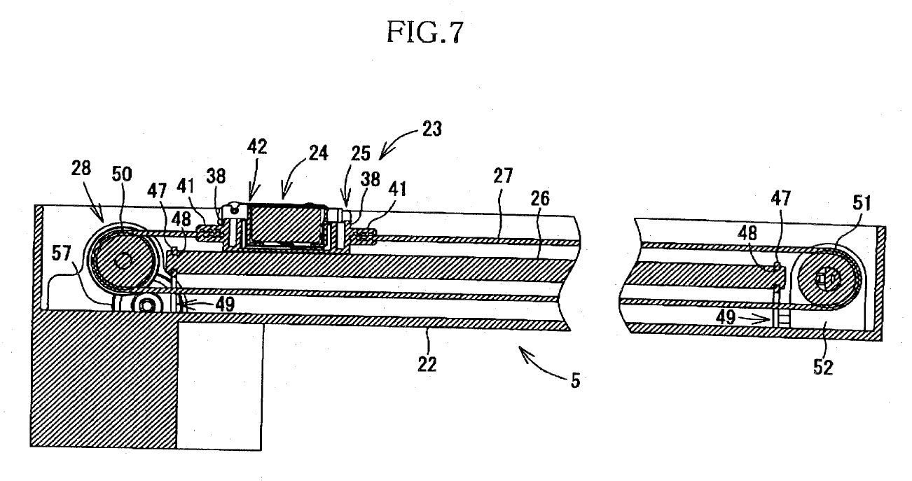

As shown in FIGS. 3 and 7, the guide rod 26 is supported at its opposite ends by respective support members 47 protruding upward from the bottom surface of the lower frame 22. The support members 47 are formed in a pair and spaced apart from each other in a direction of extension of the guide rod 26. As shown in FIG. 6, each support member 47 is located so as to correspond to a substantially lengthwise middle of the CIS 24 and is held in engagement with a corresponding one of grooves 48 that are formed in the circumferential surface of the guide rod 26 near its opposite ends, whereby the guide rod 26 is fixedly supported by the support members 47. Thus, the guide rod 26 is supported at a predetermined height from the bottom surface of the lower frame 22, such that the axis of the guide rod 26 is kept horizontal. As shown in FIGS. 6 and 7, each support member 47 has, at its lower end portion, a through-hole 49 into which the timing belt 27 is inserted. Thus, as the carriage 25 is supported and guided by the single guide rod 26, the number of the support members 47 for supporting the guide rod 26 is reduced to effectively utilize the space within the lower frame 22, resulting in a reduction in size and thickness of the scanning section 3.

As shown in FIGS. 3 and 7, the belt drive mechanism 28 is constituted by including a drive pulley 50 and a driven pulley 51 between which the timing belt 27 is stretched. The drive pulley 50 is disposed outwardly of one of opposite ends of the guide rod 26, and a drive force from a motor 57 is inputted to the shaft of the drive pulley 50. The rotation of the motor 57 is controlled by a control portion of the multi-function device 1, and the drive pulley 50 is rotated in accordance with the rotation of the motor 57 controlled by the control portion. The driven pulley 51 is disposed outwardly of the other of the opposite ends of the guide rod 26. That is, the drive pulley 50 and the driven pulley 51 are respectively disposed outwardly of the opposite ends of the guide rod 26. The driven pulley 51 is rotatably supported by a pulley holder 52. The pulley holder 52 is slidably movable with respect to the lower frame 22 in the direction of extension of the timing belt 27 and is urged by a spring or the like in a direction that gives tension to the timing belt 27, i.e., in a direction away from the drive pulley 50.

The timing belt 27 is formed with teeth in its inner side and has opposite ends. In the drawings, the teeth are not illustrated. The timing belt 27 wound around the drive and; driven pulley 50, 51 is held at its opposite ends by the respective holding portions 41 formed on the walls 38 of the carriage 25, whereby the timing belt 27 is connected to the carriage 25 in a loop-like form.

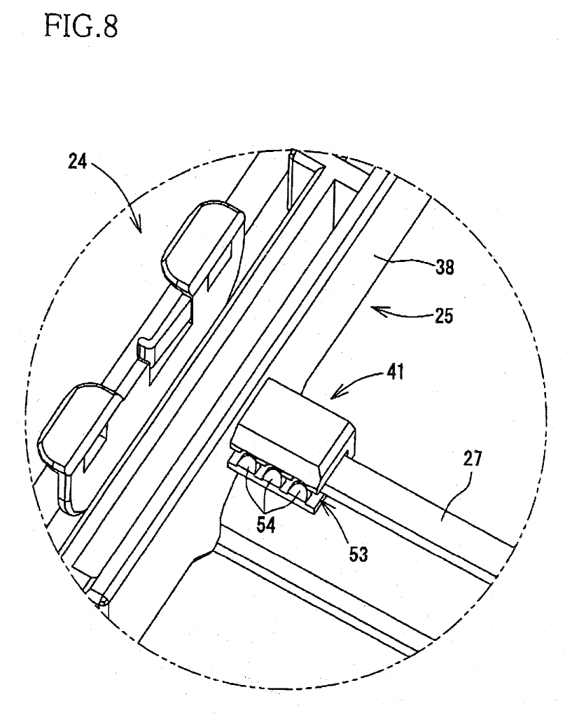

As shown in FIGS. 7 and 8, each of the holding portions 41 which protrude horizontally from the respective walls 38 of the carriage 25 has a “U” shape in cross section. Into a hollow part 53 which defines the U shape of one of the two holding portions 41, one of the opposite ends of the timing belt 27 is inserted from an open side of the hollow part 53. On the upper surface of the bottom portion of the holding portion 41 which partially defines the hollow part 53, there are formed projections 54 arranged in the direction of extension of the timing belt 27 at prescribed intervals. The projections 54 of the holding portion 41 engage with the teeth of the timing belt 27, whereby the timing belt 27 is fixed at the one of the opposite ends thereof. Similarly, the other of the opposite ends of the timing belt 27 is fixed to the other of the two holding portions 41. Thus, the timing belt 27 and the carriage 25 are connected to each other. Each of the holding portions 41 is one example for connecting the carriage 25 and the timing belt 27, and it is needless to mention that connecting structures other than the described above can be employed.

When the rotation of the motor 57 is inputted to the shaft of the drive pulley 50, the drive pulley 50 is rotated in both forward and reverse directions in accordance with the rotation of the shaft. The loop-like timing belt 27 is reciprocated along the guide rod 26 and turns around the same 26 by the rotation of the drive pulley 50, and the carriage 25 is pulled by the timing belt, so that the carriage 25 is reciprocated along the guide rod 26. The CIS 24 is reciprocated along the guide rod 26 parallel with the platen glass 20, together with the carriage 25. During the reciprocating movement of the CIS 24, the image of the document placed on the platen glass 20 is read.

Hereinafter, there will be explained a relationship between the support position at which the guide rod 26 supports the carriage 25 (i.e., the position of the rod-receiving portion 46) and the connect position at which the timing belt 27 is connected to the carriage 25 (i.e., the position of each holding portion 41).

As shown in FIG. 6, the guide rod 26 is disposed in the vicinity of a center C of the lower frame 22 in its depth direction (i.e., in a right and left direction of FIG. 6). The rod-receiving portion 46 of the carriage 25 is formed at a substantially middle in the lengthwise direction of the carriage 25. The CIS 24 is mounted on the carriage 25, and a middle of the CIS 24 substantially coincides with a middle of the carriage 25. That is, the guide rod 26 supports the carriage 25 and the CIS 24 at the substantially middles thereof. In other words, the middle of the CIS 24, the middle of the carriage 25, and the guide rod 26 lie on the center C of the lower frame 22.

The position of each holding portion 41 is determined such that a vertical line from the connect position passes the guide rod 26. That is, the position of each holding portion 41 is not displaced with respect to the support position at which the guide rod 26 supports the carriage 25, in a direction which is horizontal and perpendicular to the direction of the reciprocating movement of the carriage 25. In other words, the holding portions 41 are located right above the support position as seen in the direction of the reciprocating movement of the carriage 25. Namely, the connect position at which the timing belt 27 is connected to the carriage 25 is located right above the support position as seen in the direction of the reciprocating movement of the carriage 25. Accordingly, the support position where the sliding friction is generated in the sliding movement of the carriage 25 on the guide rod 26 and the connect position to which the force of the timing belt 27 to pull the carriage 25 is applied are located at the same position in the lengthwise direction of the carriage 25. According to the arrangement, there is generated no moment which rotates the carriage 25 with respect to the guide rod 26 when the carriage 25 is pulled by the timing belt 27.

Next, there will be considered a center of gravity of the carriage 25 carrying the CIS 24 thereon, in detail, a center of gravity of an integral unit of the CIS 24 and the carriage 25 in a state in which the CIS 24 is mounted on the carriage 25. The weights of both of the carriage 25 and the CIS 24 are not decentered in the lengthwise direction thereof Further, the middle of the CIS 24 and the middle of the carriage 25 substantially coincide with each other. Therefore, the center of gravity G1 (FIG. 5) of the carriage 25 carrying the CIS 24 thereon is located right above the guide rod 26 as seen in the direction of the reciprocating movement of the carriage 25, i.e., right above the support position as seen in the same direction. As shown in FIG. 5, the holding portions 41 are located within a plane which includes the center of gravity GI of the carriage 25 and which is vertical and parallel with respect to the direction of the reciprocating movement of the carriage 25. In detail, the holding portions 41 are located on a straight line which passes the center of gravity GI of the carriage 25 and which extends in the direction of the reciprocating movement of the carriage 25. Namely, the pulling force that acts on the connect position is not offset from the center of gravity G1 of the carriage 25. Accordingly, the force which is applied from the timing belt 27 to the carriage 25 is balanced with respect to the center of gravity G1 of the carriage 25 carrying the CIS 24 thereon As a result, there is generated no moment that rotates the carriage 25 with respect to the guide rod 26 when the carriage 25 is pulled by the timing belt 27.

The holding portions 41 are formed on the respective walls 38 which are side surfaces in the direction of the reciprocating movement of the carriage 25, and the rod-receiving portion 46 is formed on the underside of the carriage 25. Namely, the connect position at which the timing belt 27 is connected to the carriage 25 is located at a higher level than the support position at which the guide rod 26 supports the carriage 25. This arrangement is effective to reduce a space in the vertical direction required for winding the drive pulley 50 and the driven pulley 51 around the timing belt 27. Suppose that each holding portions 41 is formed at a position below the rod-receiving portion 46, it is possible to prevent the rotation moment from being generated. The arrangement, however, requires a space below the rod-receiving portion 46 for disposing the drive and driven pulleys 50, 51 to wind, around the same 50, 51, the timing belt 27 that is fixed to and held by the holding portions 41. In the exemplary embodiment, the connect position, (i.e., the holding portions 41) at which the timing belt 27 is connected to the carriage 25 is disposed above the support position at which the guide rod 26 supports the carriage 25. Further, the timing belt 27 is wound around the drive and driven pulleys 50, 51 which are disposed outwardly of the opposite ends of the guide rod 26, such that the timing belt 27 encloses the guide rod 26. This arrangement is effective to reduce a space below the rod-receiving portion 46 required for winding the timing belt 27 around the drive and driven pulleys 50, 51. Accordingly, the thickness of the document placing board 5 constituting the scanning section 3 can be reduced, making it possible to reduce the thickness of the multi-function device 1.

In the scanning section 3 constructed as described above, the connect position (i.e., the holding portions 41) at which the timing belt 27 is connected to the carriage 25 is not displaced with respect to the support position at which the guide rod 26 supports the carriage 25, in the direction which is horizontal and perpendicular to the direction of the reciprocating movement of the carriage 25. According to the arrangement, there is generated no moment that rotates the carriage 25 with respect to the guide rod 26 due to the force applied to the carriage 25 from the timing belt 27, so that the force applied from the timing belt 27 to the carriage 25 is balanced in the lengthwise direction of the CIS 24. Therefore, the CIS 24 is prevented from being inclined during its reciprocating movement for the image reading, thereby assuring stable and accurate image reading.

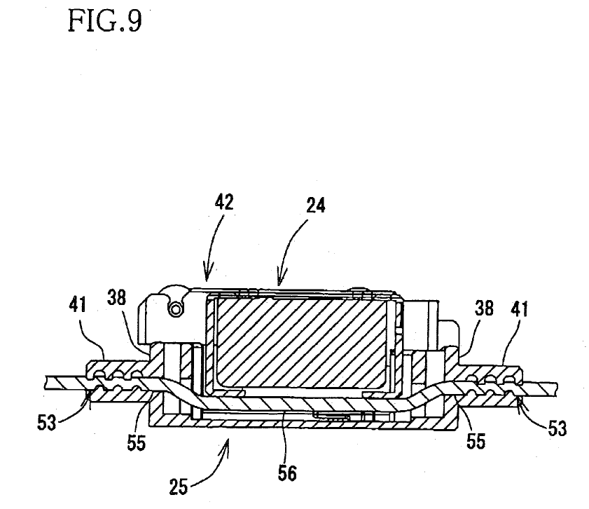

In the exemplary embodiment, while the timing belt 27 has the opposite ends, the timing belt 27 may be an endless belt. Described in detail with reference to FIG. 9, each wall 38 of the carriage 25 is formed with a through-hole 55 so as to communicate with the hollow part 53 of each holding portion 41. The through-holes 55 are open in the respective walls 38, and an endless timing belt 56 with a loop-like form (the pulling member) is inserted into the through-holes 55. The timing belt 56 is inserted into the through-holes 56 so as to penetrate the carriage 25 and held by the holding portions 41, whereby the timing belt 56 is connected to the carriage 25. The position of each holding portion 41, that is, the connect position, is the same as described above. Thus, the same advantages as described above can be obtained using the endless, loop-like timing belt 56.

### Second Embodiment

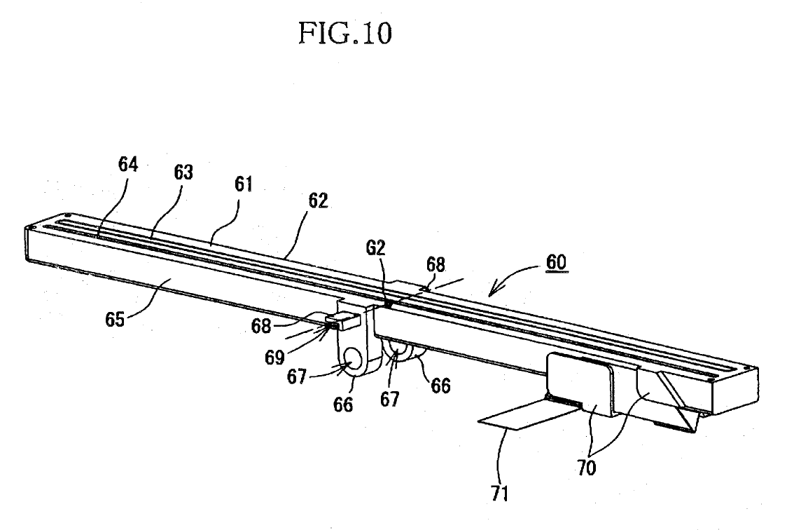

There will be next explained a second embodiment of the invention referring to FIG. 10. In the illustrated first embodiment, the CIS 24 is mounted on the carriage 25, and the carriage 25 is supported by the guide rod 26 while the timing belt 27 is connected to the carriage 25 by the holding portions 41 formed on the carriage 25. In the exemplary second embodiment, a CIS 60 is not mounted on a carriage as a separate member, but is supported directly by the guide rod 26 while being connected to the timing belt 27. Accordingly, the scanning section 3 in the exemplary second embodiment is identical in construction with the scanning section 3 in the illustrated first embodiment except for the CIS 60. In the second embodiment, the same reference numerals as used in the illustrated first embodiment are used to identify the corresponding components, and a detailed explanation of which is dispensed with. Hereinafter, the construction of the CIS 60 will be explained.

As shown in the perspective view of FIG. 10, the CIS 60 has an upper surface 61 which is an elongate, rectangular flat surface in its plan view and a case 62 whose overall configuration is elongate, rectangular parallelepiped. On the upper surface 61 of the case 62, there is provided a light guide 63 extending in the longitudinal direction of the case 62, for guiding a light of LED incorporated in the case 62. The light of the LED is emitted through the light guide 63 toward the upper surface 61 of the case 62 of the CIS 60 along the longitudinal direction. On the upper surface 61 of the case 62, a condenser lens 64 composed of a plurality of lens portions is disposed in the longitudinal direction of the case 62 so as to be parallel to the light guide 63. Further, inside the case 62, a plurality of light receiving elements are arranged, right below the condenser lens 64, in a row extending in the same direction as the direction of extension of the condenser lens 64. The light emitted from the LED is reflected on the document, and the reflected light is condensed at the light receiving elements by the condenser lens 64. The light receiving elements are so-called photoelectric conversion elements which output electric signals in accordance with the intensity of the reflected light. The longitudinal direction of the case 62 of the CIS 60 corresponds to the main scanning direction in the image reading. The length of the case 62 of the CIS 60 in the main scanning direction i.e., the longitudinal size of the case 62, corresponds to the length of a medium with a maximum size that can be read by the CIS 60. The CIS 60 performs image reading along a read line corresponding to the longitudinal direction of the case 62 of the CIS 60 and outputs electric signals for every read line.

The CIS 60 has walls 65 which are side surfaces of the case 62 in its reciprocating movement, i.e., side surfaces in the widthwise direction of the case 62. On the walls 65, a pair of boss portions 66 are formed integrally with the case 62 so as to be located in a middle of the lengthwise direction of the case 62. Each boss portion 66 is an elongate, flat plate extending in the vertical direction and protrudes downward from the bottom surface of the case 62. At a part of each boss portion 66 protruding from the case 62, there is formed a through-hole 67 as a guide-member engaging portion that extends in the widthwise direction of the case 62. The through-holes 67 are circular holes formed on the common axis. The guide rod 26 is inserted into the through-holes 67, whereby the CIS 60 is slidably supported by the guide rod 26. Namely, the position of each through-hole 67 corresponds to the support position according to the present invention.

On each of the boss portions 66, there is formed a holding portion 68 for holding the timing belt 27 and thereby connecting the-CIS 60 and the timing belt 27 to each other. That is, the position of each holding portion 68 corresponds to the connect position according to the present invention. Each holding portion 68 protrudes horizontally from the corresponding boss portion 66 and has a “U” shape in cross section. Into hollow parts 69 that define the “U” shape of the respective holding portions 68, the timing belt 27 is inserted from open sides of the respective hollow parts 69. While not shown, like the holding portions 41 of the illustrated first embodiment, each of the holding portions 68 has, on the upper surface of the bottom portion which partially defines the hollow part 69, projections which are formed to extend in the direction of extension of the timing belt 27 at prescribed intervals. The projections in each holding portion 68 are to be held in engagement with the teeth of the timing belt 27, whereby the timing belt 27 is held by and fixed to the holding portions 68 at the respective opposite ends thereof. Thus, the timing belt 27 and the CIS 60 are connected to each other. It is to be understood that each holding portion 68 is one example for connecting the CIS 24 and the timing belt 27 and that connecting structures other than the described above may be employed.

At one of longitudinal opposite ends of one of the two walls 65 of the case 62, there is provided a cable holding portion 70 which has a configuration in which a flat plate is deflected in a hook-like form. Into a clearance between the cable holding portion 70 and the case 62, a flat cable 71 is inserted, whereby the flat cable 71 is fixed while being held by and between the cable holding portion 70 and the case 62. The flat cable 71 is connected to the CIS 60 for supplying an electric power thereto and transmitting the electric signals outputted from the light-receiving elements.

The structure in which the guide rod 26 is supported by the lower frame 22 by means of the supporting members 47 and the structure of the belt drive mechanism 28 for reciprocating the timing belt 27 are similar to those described above with respect to the illustrated first embodiment, and a detailed explanation of which is dispensed with. The supporting members 47 disposed on the bottom surface of the lower frame 22 may be arranged to support the guide rod 26 such that the guide rod 26 is movable over a prescribed range in the vertical direction, and elastic members such as coil springs may be provided for urging the guide rod 26 upward. According to the arrangement, the CIS 24 supported by the guide rod 26 is elastically urged with respect to the platen glass 20, whereby a distance between the platen glass 20 and the upper surface 61 of the CIS 24 is kept constant and the CIS 24 moves upward and downward following deflection of the platen glass 20, etc.

As shown in FIG. 10, each of the through-holes 67 formed in the respective boss portions 66 of the CIS 24 is located at a substantially lengthwise middle of the CIS 24. The guide rod 26 is inserted into the through-holes 67, whereby the guide rod 26 supports the CIS 24 at the substantially lengthwise middle of the CIS 24. Namely, the support position at which the guide rod 26 supports the CIS 60 is located at the substantially lengthwise middle of the CIS 60.

The position of each holding portion 68 is determined such that a vertical line from the connect position passes the guide rod 26. That is, the position of each holding portion 68 is not displaced with respect to the support position at which the guide rod 26 supports the CIS 60, in a direction which is horizontal and perpendicular to the direction of the reciprocating movement of the CIS 60. In other words, the holding portions 68 are located right above the support position as seen in the direction of the reciprocating movement of the CIS 60. Namely, the connect position at which the timing belt 27 is connected to the CIS 60 is located right above the support position as seen in the direction of the reciprocating movement of the CIS 60. Accordingly, the support position where the sliding friction is generated in the sliding movement of the CIS 60 on the guide rod 26 and the connect position to which the force of the timing belt 27 to pull the CIS 60 is applied are located at the same position in the lengthwise direction of the CIS 60. According to the arrangement, there is generated no moment which rotates the CIS 60 with respect to the guide rod 26 when the CIS 60 is pulled by the timing belt 27.

Because the weight of the CIS 60 is not decentered in the lengthwise direction thereof, the center of gravity G2 (FIG. 10) of the CIS 60 is located right above the guide rod 26 as seen in the direction of the reciprocating movement of the CIS 60, i.e., right above the support position as seen in the same direction. As shown in FIG. 10, the holding portions 68 are located within a plane which includes the center of gravity G2 of the CIS 60 and which is vertical and parallel with respect to the direction of the reciprocating movement of the CIS 60. In detail, the holding portions 68 are located on a straight line which passes the center of gravity G2 of the CIS 60 and which extends in the direction of the reciprocating movement of the CIS 60. Namely, the pulling force that acts on the connect position is not offset from the center of gravity G2 of the CIS 60. Accordingly, the force which is applied from the timing belt 27 to the CIS 60 is balanced with respect to the center of gravity G2 of the CIS 60. As a result, there is generated no moment that rotates the CIS 60 with respect to the guide rod 26 when the CIS 60 is pulled by the timing belt 27.

The holding portions 68 are formed on the respective walls 65 which are side surfaces in the direction of the reciprocating movement of the CIS 60, and the through-holes 67 are formed on the underside of the CIS 60. Namely, the connect position at which the timing belt 27 is connected to the CIS 60 is located at a higher level than the support position at which the guide rod 26 supports the CIS 60. This arrangement is effective to reduce a space in the vertical direction required for winding the drive pulley 50 and the driven pulley 51 of the belt drive mechanism 28 around the timing belt 27. Therefore, the thickness of the document placing board 50 constituting the scanning section 3 can be reduced, making it possible to reduce the thickness of the multi-function device 1.

In the second embodiment illustrated above, the connect position at which the timing belt 27 is connected to the CIS 60 is not displaced with respect to the support position at which the guide rod 26 supports the CIS 60, in the direction which is horizontal and perpendicular to the direction of the reciprocating movement of the image sensor. According to the arrangement, there is generated no moment that rotates the CIS 60 with respect to the guide rod 26 due to the force applied to the CIS 60 from the timing belt 27, so that the force applied from the timing belt to the CIS 60 is balanced in the lengthwise direction of the CIS 60. Therefore, the CIS 60 is prevented from being inclined during its reciprocating movement for the image reading, thereby assuring stable and accurate image reading.

What is claimed is:

1. An image reading device, comprising:
an image sensor which includes a case having an elongate configuration and light-receiving elements arranged in a row in a lengthwise direction of the case and which reads an image;
a carriage on which is mounted the image sensor;
a guide member which supports the carriage at a support position that corresponds to a substantially lengthwise middle of the image sensor, for guiding a reciprocating movement of the carriage;
a pulling member connected to the carriage at a connect position which is determined such that a vertical line from the connect position passes the guide member; and
a drive mechanism which reciprocates the pulling member along the guide member.

2. The image reading device according to claim 1, wherein the connect position is not displaced with respect to the support position in a direction which is horizontal and perpendicular to a direction of the reciprocating movement of the carriage.

3. The image reading device according to claim 1,
wherein the carriage has a guide-member engaging portion which is formed at a lower portion thereof corresponding to the substantially lengthwise middle of the image sensor and which engages with the guide member, and
wherein the support position is constituted by the guide-member engaging portion.

4. The image reading device according to claim 1, wherein the connect position is located within a plane which includes a center of gravity of the carriage carrying the image sensor thereon and which is vertical and parallel with respect to a direction of the reciprocating movement of the carriage.

5. The image reading device according to claim 1, wherein the connect position is located on a straight line which passes a center of gravity of the carriage carrying the image sensor thereon and which extends in a direction of the reciprocating movement of the carriage.

6. The image reading device according to claim 1, wherein the connect position is located at a higher level than the support position.

7. The image reading device according to claim 6,
wherein the pulling member is a timing belt, and the drive mechanism includes a pair of pulleys which are disposed outwardly of respective opposite end portions of the guide member and around which the timing belt is wound, and
wherein the timing belt is wound around the pair of pulleys so as to enclose the guide member.

8. The image reading device according to claim 1, wherein the pulling member is a timing belt having opposite ends each of which is connected to the carriage at the connect position provided on either of side surfaces of the carriage in a direction of the reciprocating movement thereof.

9. The image reading device according to claim 1, wherein the pulling member is an endless timing belt which penetrates the carriage and which is connected to the carriage at the connect position.

10. The image reading device according to claim 1, wherein the image sensor is a contact image sensor comprising: a light source which emits a light on a medium to be read; a lens which condenses a reflected light from the medium to be read; and the light-receiving elements which output electric signals in accordance with intensity of the reflected light condensed by the lens.

11. An image reading device, comprising:
an image sensor which includes a case having an elongate configuration and light-receiving elements arranged in a row in a lengthwise direction of the case and which reads an image;
a guide member which supports the image sensor at a support position that corresponds to a substantially lengthwise middle of the image sensor, for guiding a reciprocating movement of the image sensor;
a pulling member connected to the image sensor at a connect position which is determined such that a vertical line from the connect position passes the guide member; and
a drive mechanism which reciprocates the pulling member along the guide member.

12. The image reading device according to claim 11, wherein the connect position is not displaced with respect to the support position in a direction which is horizontal and perpendicular to a direction of the reciprocating movement of the image sensor.

13. The image reading device according to claim 11,
wherein the image sensor has a guide-member engaging portion which is formed at a lower portion of a substantially lengthwise middle of the case and which engages with the guide member, and
wherein the support position is constituted by the guide-member engaging portion.

14. The image reading device according to claim 11, wherein the connect position is located within a plane which includes a center of gravity of the image sensor and which is vertical and parallel with respect to a direction of the reciprocating movement of the image sensor.

15. The image reading device according to claim 11, wherein the connect position is located on a straight line which passes a center of gravity of the image sensor and which extends in a direction of the reciprocating movement of the image sensor.

16. The image reading device according to claim 11, wherein the connect position is located at a higher level than the support position.

17. The image reading device according to claim 16,
wherein the pulling member is a timing belt, and the drive mechanism includes a pair of pulleys which are disposed outwardly of respective opposite end portions of the guide member and around which the timing belt is wound, and
wherein the timing belt is wound around the pair of pulleys so as to enclose the guide member.

18. The image reading device according to claim 11, wherein the pulling member is a timing belt having opposite ends each of which is connected to the image sensor at the connect position provided on either of side surfaces of the image sensor in a direction of the reciprocating movement thereof.

19. The image reading device according to claim 11, wherein the image sensor is a contact image sensor comprising: a light source which emits a light on a medium to be read; a lens which condenses a reflected light from the medium to be read; and the light-receiving elements which output electric signals in accordance with intensity of the reflected light condensed by the lens.
